(19) United States
(12) Patent Application Publication
(10) Pub. No.: US 2008/0080014 A1
(43) Pub. Date: Apr. 3, 2008

(54) COMPOSITE MACHINE HAVING FACSIMILE FUNCTION, METHOD FOR HOLDING FACSIMILE DATA, AND COMPUTER PROGRAM PRODUCT

(75) Inventor: Kazuhiko SHIMAMOTO, Shiojiri-shi (JP)

Correspondence Address: SUGHRUE MION, PLLC, 2100 Pennsylvania Avenue, N.W., Washington, DC, 20037, US

(73) Assignee: Seiko Epson Corporation, Tokyo (JP)

(21) Appl. No.: 11/866,639

(22) Filed: Oct. 3, 2007

(30) Foreign Application Priority Data
Oct. 3, 2006 (JP) 2006-271676
Jul. 30, 2007 (JP) 2007-197499

(51) Int. Cl. H04N 1/00

(52) U.S. Cl. 358/442

(57) ABSTRACT

A composite machine for printing facsimile data received by using facsimile communication, including: a first non-volatile storage device having a storage area of a predetermined capacity; a second non-volatile storage device that is capable of storing data at higher speed than the first storage device, and having a storage area smaller than the predetermined capacity; a temporary storage unit for storing the facsimile data in the second storage device; a print execution unit for executing printing when the storing of the facsimile data is completed, when printing is possible; and a backup unit for storing the facsimile data in the first storage device when the storing of the facsimile data is completed, when printing is not possible.

### BACKGROUND

1. Technical Field

The present invention relates to a composite machine having a facsimile (hereinafter, fax) function, and more particularly, to a composite machine that prints received fax data.

2. Related Art

Typically, composite machines having fax functions use, as a memory for storing fax data, a volatile storage device in which data can be written at high speed, for example, DRAM (Dynamic Random Access Memory) or SRAM (Static Random Access Memory).

For this reason, if, after storing fax data in the volatile storage device, the power is cut off before the completion of printing, the fax data will be lost.

For composite machines having fax functions, this problem is serious. This is because, typically, even if the power is cut off before the completion of printing after storing fax data, the composite machine cannot know that the received fax data has been lost. Furthermore, at this point, since the sending device of the fax data has successfully completed fax communication with the composite machine, the user cannot know that the fax data was lost at the composite machine, and the sending device does not resend the fax data.

Consequently, a composite machine that can hold fax data even in cases where the power is cut off is desired.

In order to realize such a composite machine, it is conceivable to use a non-volatile storage device that, although the data write speed thereof is slow, can hold fax data even in cases where the power is cut off; for example, FlashROM or a HDD.

However, it is necessary for fax data to be stored in a storage device within the communication time prescribed in the fax communication standard. For this reason, if a non-volatile storage device with slow data write speed, like the above-described, is used in a composite machine having a fax function, communication errors may occur.

In order to avoid this problem, it is conceivable to use a storage device such as FRAM (FeRAM), which is non-volatile and has comparatively high write speed.

However, even using the above storage device, there are cases wherein received fax data cannot be printed, due to causes such as printing paper not being loaded. In these cases, since there is a possibility that the need will arise to hold the fax data from a plurality of communication sessions until printing is completed, the storage device must be large-capacity. For this reason, memory-related costs increase.

### SUMMARY

An advantage of some aspects of the invention is that a composite machine having a fax function is realized at lower cost, which, after storing received fax data at high speed, can hold the fax data until printing is completed, even in cases where power is cut off before printing is completed.

According to some aspects of the invention, received fax data is stored in a small-capacity storage device that can be written to at high speed, and subsequently, in cases where printing cannot be conducted at that time, the fax data stored in the small-capacity storage device is stored in a large-capacity storage device that is written to at low speed.

Specifically, a composite machine like the above-described, being a composite machine for printing facsimile data received via facsimile communication, includes the following: a non-volatile first storage device that has a storage area of a predetermined capacity; a non-volatile second storage device, having a storage area of capacity smaller than the predetermined capacity, that is able to store data at higher speed than the first storage device is; a temporary storage unit that stores the facsimile data in the second storage device; a printing execution unit that executes printing when the storage of the facsimile data is completed when printing is possible; a backup unit that stores the facsimile data in the first storage device when the storage of the facsimile data is completed when printing is not possible.

Hereinafter, specific embodiments of the invention will be described, but it should be appreciated that configurations offered herein are to be accorded the utmost freedom in combinations thereof, and any of those combinations are to be taken as configurations of the invention. In other words, configurations in which a portion of the configuration has been suitably removed from the embodiments hereinafter described are potentially other embodiments of the invention. In addition, any one of the configurations specifically illustrated hereinafter is no more than one lower level concept among higher level concepts of the invention, and is identical thereto with regard to function.

### BRIEF DESCRIPTION OF THE DRAWINGS

FIG. 1 is a block diagram showing an example configuration of a printing system in accordance with an embodiment of the invention;

FIG. 2A conceptually illustrates data stored in the small-capacity storage unit;

FIG. 2B conceptually illustrates data stored in the large-capacity storage unit;

FIG. 3 conceptually illustrates the data layout of the management information;

FIG. 4 shows an example of the functional configuration of the printing system;

FIG. 5 is a flowchart for describing the power-on processing executed in a composite machine in accordance with an embodiment of the invention; and

FIG. 6 is a flowchart for describing the backup processing executed in a composite machine in accordance with an embodiment of the invention.

### DESCRIPTION OF EMBODIMENTS

According to the composite machine of the invention, being a composite machine having a fax function, a composite machine can be realized at low cost that, after storing received fax data at high speed, can hold the fax data until printing is completed, even in when the power is cut off before printing is completed.

Hereinafter, exemplary embodiments of the invention will be described with reference to the accompanying drawings.

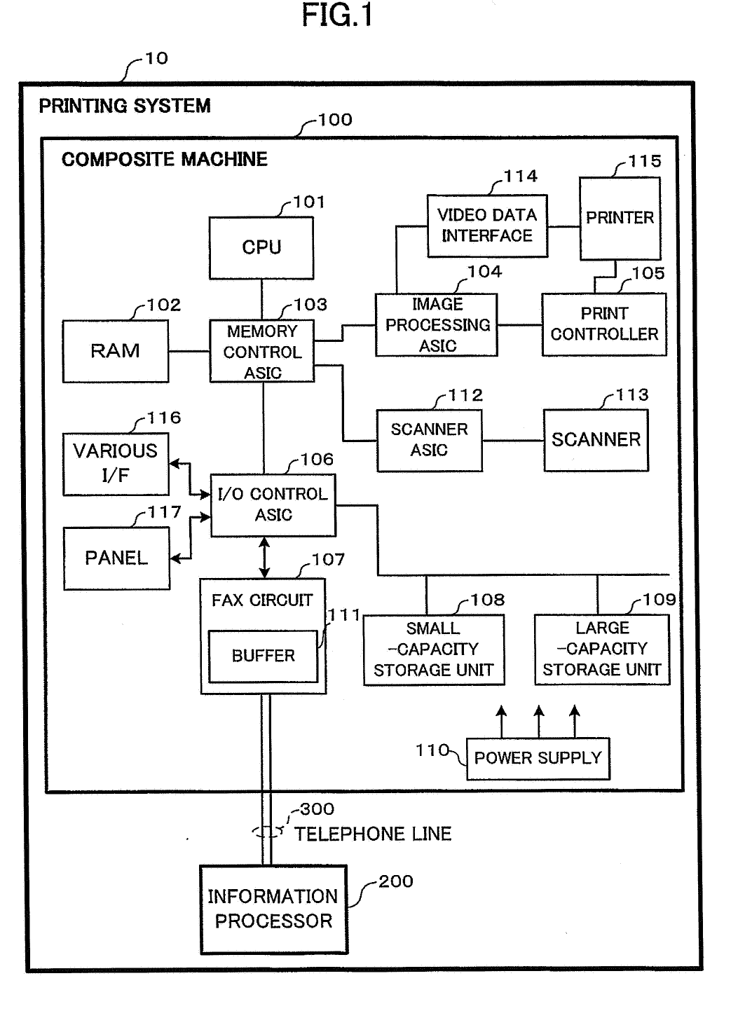

As shown in FIG. 1, a printing system 10 applied to an embodiment of the invention includes a composite machine 100 having a fax function, and an information processor 200 that sends fax data to the composite machine 100 via a telephone line 300. Furthermore, besides the fax function, the composite machine 100 also has at least one of the following functions: a local print function, a network print function, or a copy function.

The composite machine 100 receives fax data sent from the information processor 200, performs predetermined decompression processing, performs predetermined image processing, and subsequently generates and prints print data.

In addition, the composite machine 100 also has: a large-capacity storage unit 109, being a non-volatile storage device having a storage area of a predetermined capacity; and a non-volatile small-capacity storage unit 108, which can store data at higher speed than the large-capacity storage unit 109, and whose storage area is of smaller capacity than the large-capacity storage unit 109.

The composite machine 100 temporarily stores the received fax data in the small-capacity storage unit 108. At this point, in cases where printing can be executed, the composite machine 100 executes printing of the fax data. In cases where printing cannot be executed, the composite machine 100 backs up the fax data stored in the small-capacity storage unit 108 to the large-capacity storage unit 109. When the composite machine 100 returns to a state where printing can be executed, the fax data backed up to the large-capacity storage unit 109 is printed.

Consequently, in the printing system 10 of the present embodiment, the composite machine 100 stores at high speed the fax data received from the information processor 200 in the small-capacity storage unit 108, and subsequently holds the fax data until printing is completed, even in cases where the power is cut off before printing is completed.

In addition, since the small-capacity storage unit 108 is a non-volatile storage device that can store data at high speed, it is comparatively costly, but by making the storage area thereof comparatively smaller, the costs can be curtailed. Since the large-capacity storage unit 109 is a storage device that writes data at lower speed than the small-capacity storage unit 108 does, the costs remain reasonable for making the storage area larger. In other words, the total memory-related costs in the printing system 10 of the present embodiment can be curtailed.

However, the configuration of the printing system 10 is not limited to the above. For example, the information processor 200 may consist of a plurality of devices. In addition, the composite machine 100 need not have a printing function. In this case, the composite machine 100 may send the print data to a printer or other device having a printing function.

Next, the hardware configuration of the composite machine 100 will be described.

As shown in FIG. 1, the composite machine 100 includes a CPU (Central Processing Unit) 101 for executing various programs, and RAM (Random Access Memory) 102 for temporarily storing data, programs, etc. In addition, the composite machine 100 also includes the following: a memory control ASIC 103 controls the plurality of memory areas; an image processing ASIC 104 converts fax data into print data; a print controller 105 controls a printer 115; an I/O control ASIC 106 controls various I/O devices (not shown) via various interfaces (I/F) 116; a fax circuit 107 sends and receives fax data to and from the information processor 200 via a telephone line 300. Furthermore, as described in the foregoing, the composite machine 100 includes a small-capacity storage unit 108, and a large-capacity storage unit 109. In addition, the composite machine 100 includes a scanner ASIC 112 for controlling a scanner 113. Furthermore, the composite machine 100 includes: a power supply 110 for supplying power to various devices; and a panel 117 that displays a list of printable data, and which allows a user to select therefrom data to print. In addition, the composite machine 100 is also configured to include a video data interface 114 that develops data into a format capable of video output (hereinafter, referred to as video data), and then sends this data to the printer 115, along with control commands for the data to be printed.

The CPU 101 conducts overall control of the composite machine 100. In addition, the CPU 101 loads various programs, and executes predetermined processing based on the programs. For example, the CPU 101 conducts processing to print or backup received fax data, start processing conducted at power-on, etc. The various processing executed by the CPU 101 will be described in later sections.

The RAM 102 is a volatile memory for storing various programs loaded by the CPU 101 to execute predetermined processing, or for storing data necessary for the CPU 101 to execute various programs.

The memory control ASIC 103 is an integrated circuit for controlling the exchange of data among a plurality of memory areas, such as the RAM 102, the small-capacity storage unit 108, and the large-capacity storage unit 109. For example, the memory control ASIC 103, based on commands from the CPU 101, provides the small-capacity storage unit 108 with a control signal for forwarding fax data to the large-capacity storage unit 109 when backing up the fax data.

The image processing ASIC 104 is an integrated circuit for conducting conversion processing of fax data into print data when printing. The image processing ASIC 104 provides converted print data to the print controller 105 or the video data interface 114.

The print controller 105 controls the printer 115. Specifically, the print controller 105 generates print image data based on the print data provided by the image processing ASIC 104, and sends this print image data to the printer 115, to be printed.

The video data interface 114 sends video data to the printer 115, to be printed. Specifically, the video data interface 114 develops the print data provided by the image processing ASIC 104 into video data with a page per frame, and sends this video data along with control commands to the printer 115, to be printed.

The printer 115, following commands of the print controller 105 or the video data interface 114, executes printing on a printing medium, such as printing paper, with a print engine (not shown in the drawings). In addition, the printer 115 holds in a memory (not shown in the drawings) status specification data for specifying whether or not the device is in a print-ready state. When requested, the printer 115 replies with a signal indicating whether or not it is in a print-ready state, based on this status specification data. Furthermore, the printer 115, when not conducting print processing, holds status specification data as data indicating that the device is in a print-ready state; once print processing has commenced, the device changes the status specification data to data indicating that it is in a busy state and cannot print. In addition, when this print processing has ended, the status specification data is reverted again to data indicating that the device is in a print-ready state. Separately and in addition to this, when the device is in a state where it cannot print, such as when the print engine is in an error state, or a state wherein printing paper is not set in the device, the status specification data is changed to data indicating that the device is a state where it cannot print. It should be appreciated that a circuit may also be used to implement this function, instead of using status specification data.

The scanner ASIC 112 is an integrated circuit for controlling the scanner 113. The scanner ASIC 112 provides image data generated by the scanner 113 to the memory control ASIC 103.

The scanner 113, based on commands from the scanner ASIC 112, optically converts photos or illustrations of the original into digital data, thereby generating image data. The scanner 113 provides the generated image data to the scanner ASIC 112. Furthermore, the composite machine 100, having a copy function, can cause the printer 115 to print the image data generated by the scanner 113, thereby making a copy of the original.

The I/O control ASIC 106 is an integrated circuit for controlling various I/O devices. For example, the I/O control ASIC 106 controls the sending and receiving of data to and from components such as the fax circuit 107, the small-capacity storage unit 108, the large-capacity storage unit 109, the various interfaces (I/F) 116, and the panel 117. Furthermore, the various interfaces (I/F) 116 are interfaces for conducting the sending and receiving of data among various devices, for example: USB devices, devices conducting parallel communications, USB hosts, hard disks, devices conducting communications via a network, etc. In addition, the composite machine 100, having a local print function, can cause the printer 115 to print image (or print) data sent from a USB device connected to the various interface 116. Furthermore, the composite machine 100, having a network print function, can cause the printer 115 to print image (or print) data sent from a device connected to the various interfaces 116 via a network.

The panel 117 includes an LCD display or the like, displays data for notifying a user, and receives command input by the user's touch operations. For example, the panel 117 displays a list of the fax data that has been backed up to the large-capacity storage unit 109, and receives commands selecting at least one data item to print from among the list.

The fax circuit 107 conducts the sending and receiving of fax data to and from the information processor 200 via the telephone line 300. The fax circuit 107 temporarily stores the received fax data in a buffer 111 provided therein, and subsequently forwards the data to the small-capacity storage unit 108. In addition, the fax circuit 107 can allow or refuse the reception of fax data from the information processor 200, based on commands from the CPU 101. Specifically, this can be implemented in the fax circuit 107 by switching a switch provided within the circuit.

In the present embodiment, after receiving fax data, the fax circuit 107 is configured so as to refuse the reception of subsequent fax data until the printing of the first fax data is completed, or alternatively, until the backup thereof is completed.

As described in the foregoing, the small-capacity storage unit 108 is a non-volatile storage device that can store data at higher speed than the large-capacity storage unit 109 can, and whose storage area is of smaller capacity than that of the large-capacity storage unit 109. For example, it is preferable for FRAM (Ferroelectric Random Access Memory) or MRAM (Magnetoresistive Random Access Memory) to be used as the small-capacity storage unit 108.

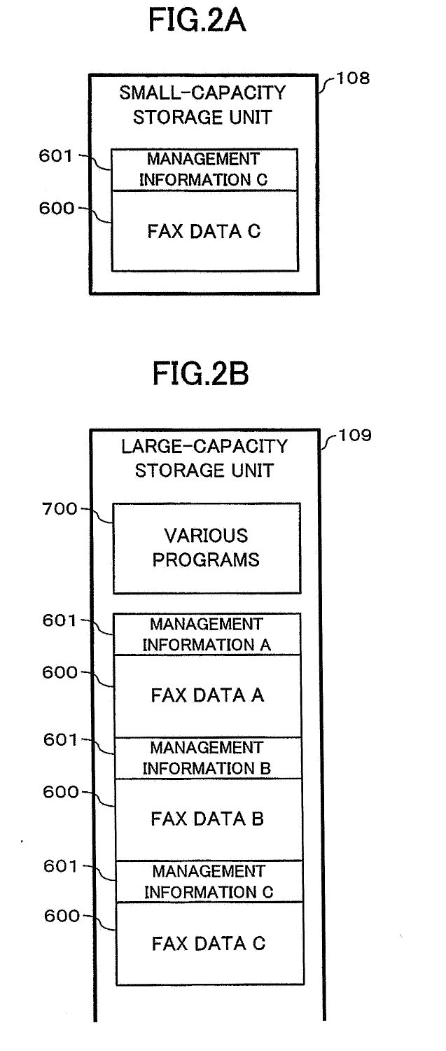

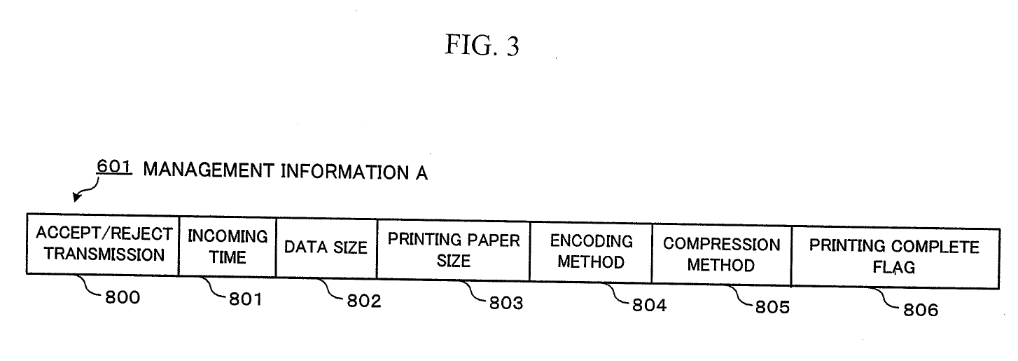

As shown in FIG. 2A, fax data 600 received by the fax circuit 107 is temporarily stored in the small-capacity storage unit 108. In addition, at this point management information 601 generated by the CPU 101 is appended to the fax data 600. This management information 601 includes data for the CPU 101 to manage the fax data 600. For example, as shown in FIG. 3, the management information 601 includes accept/reject transmission 800, incoming time (reception time) 801, data size 802, printing paper size 803, encoding method 804, compression method 805, and a printing complete flag 806. In the printing complete flag 806 herein, a “1” is stored in cases where printing of the fax data 600 is completed, and a “0” is stored in cases where printing is not completed.

In addition, since the storage capacity of the small-capacity storage unit 108 is small, only the received fax data in one fax communication at a time can be stored. The fax data 600, being temporarily stored in the small-capacity storage unit 108, is overwritten by subsequently received fax data 600.

It should be appreciated that the small-capacity storage unit 108 may also be a volatile storage device, for example, SRAM (Static Random Access Memory). However, in this case, when the power from the power supply 110 of the composite machine 100 is cut off, it is necessary to configure the power to be provided to the small-capacity storage unit 108 independently of the power supply 110, in order for the fax data not to be lost.

Returning to FIG. 1, the large-capacity storage unit 109 is a non-volatile storage device having a storage area of predetermined capacity, as described in the foregoing. For example, it is preferable for a HDD, FlashROM, etc., to be used as the large-capacity storage unit 109.

As shown in FIG. 2B, backup data of the fax data 600 being temporarily stored in the small-capacity storage unit 108 is stored in the large-capacity storage unit 109. The management information (ancillary information) 601 stored in the small-capacity storage unit 108 is also appended to the fax data 600 stored in the large-capacity storage unit 109. This storage of backup data to the large-capacity storage unit 109 is conducted when the fax data 600 stored in the small-capacity storage unit 108 cannot be printed.

It should be appreciated that cases when the fax data 600 cannot be printed as stated herein also includes cases such as when the print engine of the printer 115 is in an error state, or when the printer 115 is being used by other functions (for example, the local print function, the network print function, or the copy function).

In addition, since the storage capacity of the large-capacity storage unit 109 is larger than that of the small-capacity storage unit 108, fax data 600 received from a plurality of fax communications can be stored therein.

Furthermore, various programs 700 executed by the CPU 101 are stored in the large-capacity storage unit 109. These various programs 700 include programs for executing print/backup processing, and processing conducted at power-on.

Returning to FIG. 1, the power supply 110 is a device for providing power to every device provided in the composite machine 100. In cases where the power provided by the power supply 110 is cut off, every device halts the operation. For example, the composite machine 100 cannot conduct any processing, such as reception of fax data, storage of fax data in the small-capacity storage unit 108, backup to the large-capacity storage unit 109, printing, etc.

The composite machine 100 includes the above configuration. However, the configuration of the composite machine 100 is not limited to the above.

The information processor 200 can send generated fax data to the composite machine 100 via the telephone line 300. For example, the information processor 200 may be a typical telephone equipped with a fax function, a composite machine equivalent to the composite machine 100, or a typical computer.

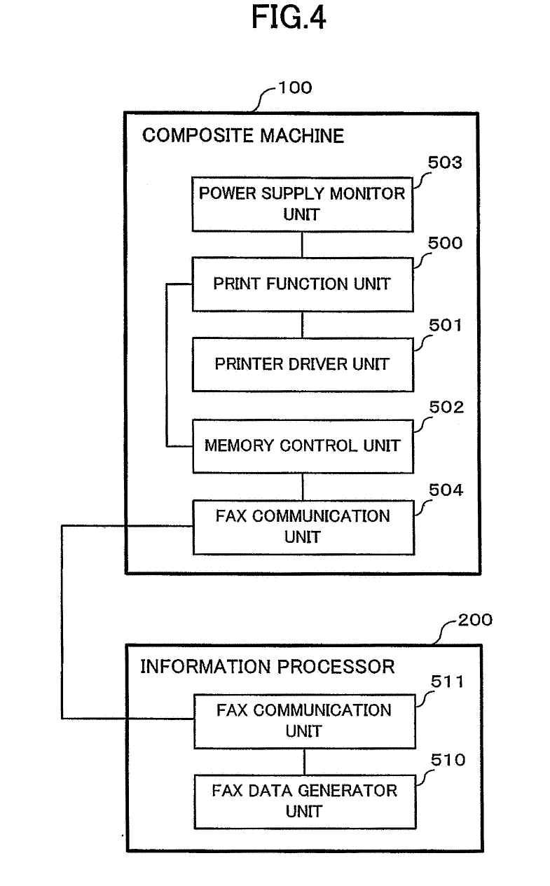

Next, the functional configuration realized in the printing system 10 as described above will be described with reference to FIG. 4.

As shown in FIG. 4, built into the composite machine 100 are a print function unit 500, a printer driver unit 501, a memory control unit 502, a power monitor unit 503, and a fax communication unit 504

The print function unit 500 interprets the fax data 600 stored in the small-capacity storage unit 108 and the large-capacity storage unit 109, and generates print data based on the fax data 600. The print function unit 500 then passes the generated print data to the printer driver unit 501, to be hereinafter described. In addition, the print function unit 500 can also generate print data based on image data generated by the scanner 113, or image data sent from various devices via the various interfaces 116. In this case as well, the print function unit 500 passes the generated print data to the printer driver unit 501.

In addition, the print function unit 500 cooperates with the memory control unit 502 (to be hereinafter described) to control the exchange of fax data among each of the fax data memories (the RAM 102, the small-capacity storage unit 108, and the large-capacity storage unit 109) according to the status of the composite machine 100. Specifically, the print function unit 500, upon receiving fax data from the information processor 200, stores the fax data in the small-capacity storage unit 108. In addition, the print function unit 500, after storing the fax data in the small-capacity storage unit 108, determines whether or not printing can be executed; in cases where printing cannot be executed, the fax data is forwarded to the large-capacity storage unit 109. It should be appreciated that cases wherein printing cannot be executed includes, for example, cases wherein an error has occurred in the print engine, cases wherein the printer 115 is in use by a function other than the fax function (for example, the local print function, the network print function, the copy function, etc.), or cases wherein printing paper is not inserted into the paper feed mechanism.

Furthermore, the print function unit 500 cooperates with the power monitor unit 503 as well as the memory control unit 502 (to be hereinafter described) to search for unprinted fax data 600 within each memory (the small-capacity storage unit 108 and the large-capacity storage unit 109) at power-on, or when in standby for receiving fax data. In cases where unprinted fax data 600 is present, the print function unit 500 executes printing.

The printer driver unit 501 conducts processing for executing printing; specifically it generates print image data based on the print data passed from the print function unit 500, and executes printing. In addition, the printer driver unit 501 can acquire a signal from the printer 115 that indicates whether or not printing is possible.

The fax communication unit 504 receives fax data sent from the information processor 200 via the telephone line 300. Upon receiving this fax data, the fax communication unit 504 conducts typical processing according to the fax communication standard.

In addition, the fax communication unit 504 interprets command signals from the CPU 101, and executes processing according to these command signals.

Meanwhile, built into the information processor 200 are a fax data generator unit 510, and a fax communication unit 511.

The fax data generator unit 510 generates fax data to be sent to the composite machine 100 by user-operated fax communication. Specifically, the fax data generator unit 510 causes a CCD to scan an original that the user wants to send by fax communication, thereby generating image data. The fax data generator unit 510 converts this image data into fax data in a format sendable via fax communication. However, the method of generating fax data is not limited to the above.

The fax communication unit 511 sends the fax data generated by the fax data generator unit 510 to the composite machine 100 via the telephone line 300. Basically, the fax communication unit 511 has the same function as the fax communication unit 504 built into the composite machine 100.

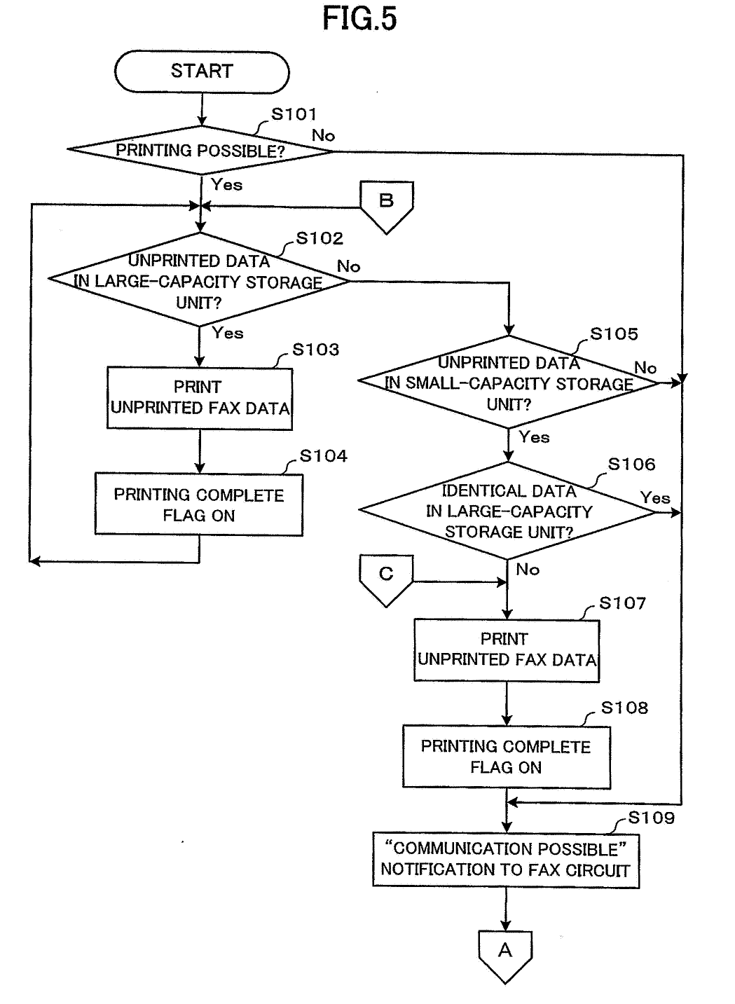

Next, the power-on processing of the composite machine 100 will be described with reference to the flowchart in FIG. 5. Power-on processing is conducted in order to print all of the fax data left unprinted in memory the last time the power was cut off.

Power-On Processing

When the power signal from the power supply 110 to the CPU 101 becomes effective (high), the power monitor unit 503 of the composite machine 100 notifies the print function unit 500 that power has been supplied to the composite machine 100. At this point, the print function unit 500 commences power-on processing. Specifically, the print function unit 500 loads into the RAM 102 a program for executing power-on processing, included in the various programs 700 stored in the large-capacity storage unit 109.

Next, the print function unit 500 determines whether or not printing is possible (step S101). Specifically, the print function unit 500 cooperates with the print driver unit 501 to acquire a signal from the printer 115 indicating whether or not printing is possible.

At this point, in cases where the print function unit 500 determines that printing is not possible (step S101; No), the process proceeds to step S109.

On the other hand, in cases where the print function unit 500 determines that printing is possible (step S101; Yes), the process proceeds to step S102.

In step S102, the print function unit 500 determines whether or not unprinted fax data 600 is stored in the large-capacity storage unit 109 (step S102). Specifically, the print function unit 500 cooperates with the memory controller 502 to access the large-capacity storage unit 109. At this point, the print function unit 500 refers to the management information 601 appended to the fax data 600, and determines whether or not the printing complete flag 806 is “0”.

In cases where the print function unit 500 determines that unprinted fax data 600 is stored in the large-capacity storage unit 109 (step S102; Yes), the unprinted fax data 600 is printed (step S103). Specifically, when the print function unit 500 determines that the printing complete flag 806 contained in the management information 601 is “0”, the print function unit 500 cooperates with the memory control unit 502 to load the fax data 600 into the RAM 102. Subsequently, the print function unit 500 forwards the fax data 600 to the image processing ASIC 104, whereby print data based on the fax data is generated. In addition, the printer driver unit 501 generates, based on the print data, print image data that can be interpreted by the printer 115. The printer driver unit 501 provides this print image data to the printer 115.

After printing is completed, the print function unit 500 sets the printing complete flag 806 to ON (step S104). Specifically, the print function unit 500 cooperates with the memory controller 502 to access the large-capacity storage unit 109. At this point, the print function unit 500 changes the printing complete flag 806 of the management information 601, which was appended to the fax data 600 printed in step S103, to “1”.

The print function unit 500 repeatedly executes the processing of the above steps S102-S104 until there is no more unprinted fax data in the large-capacity storage unit 109.

In step S102, in cases where the print function unit 500 determines that unprinted fax data 600 is not stored in the large-capacity storage unit 109 (step S102; No), the print function unit 500 determines whether or not unprinted fax data 600 is stored in the small-capacity storage unit 108 (step S105). Specifically, the print function unit 500 cooperates with the memory control unit 502 to access the small-capacity storage unit 108. At this point, the print function unit 500 refers to the management information 601 appended to the fax data 600, and determines whether or not the printing complete flag 806 is “0”.

In cases where the print function unit 500 determines that unprinted fax data 600 is not stored in the small-capacity storage unit 108 (step S105; No), the process proceeds to step S109.

On the other hand, in step S105, in cases where the print function unit 500 determines that unprinted fax data 600 is stored in the small-capacity storage unit 108 (step S105; Yes), the print function unit 500 determines whether or not fax data 600 identical to this fax data 600 stored in the small-capacity storage unit 108 is stored in the large-capacity storage unit 109 (step S106). Specifically, the print function unit 500 cooperates with the memory control unit 502 to compare the incoming time 801 of the management information 601 stored in the small-capacity storage unit 108 to the incoming time 801 of the management information 601 stored in the large-capacity storage unit 109.

By conducting the determination processing in step S106, duplicate printing of the fax data 600 can be prevented.

In cases where the print function unit 500 determines that fax data 600 identical to the fax data 600 stored in the large-capacity storage unit 109 is present in the small-capacity storage unit 108 (step S106; Yes), the process proceeds to step S109.

On the other hand, in cases where, in step S106, the print function unit 500 determines that fax data 600 identical to the fax data 600 stored in the small-capacity storage unit 108 is not present in the large-capacity storage unit 109 (step S106; No), the fax data 600 stored in the small-capacity storage unit 108 is printed (step S107). The specific processing is equivalent to the processing explained in step S1103.

After printing is completed, the print function unit 500 sets the printing complete flag 806 to ON (step S108). Specifically, the print function unit 500 cooperates with the memory control unit 502 to access the small-capacity storage unit 108. At this point, the print function unit 500 changes the printing complete flag 806 of the management information 601, which was appended to the fax data 600 printed in step S107, to “1”.

The print function unit 500 notifies the fax circuit 107 that fax communication may be enabled (step S109). Specifically, the print function unit 500 passes to the fax communication unit 504 a command to permit the receiving of fax data via the telephone line 300. At this point, the fax communication unit 504 switches a switch within the fax circuit 107 to ON.

Subsequently, the print function unit 500 goes to standby until fax data is sent from the information processor 200 to the fax circuit 107.

As a result of the composite machine 100 executing the above power-on processing, all of the fax data that was left unprinted in the memory the last time the power was cut off can be printed.

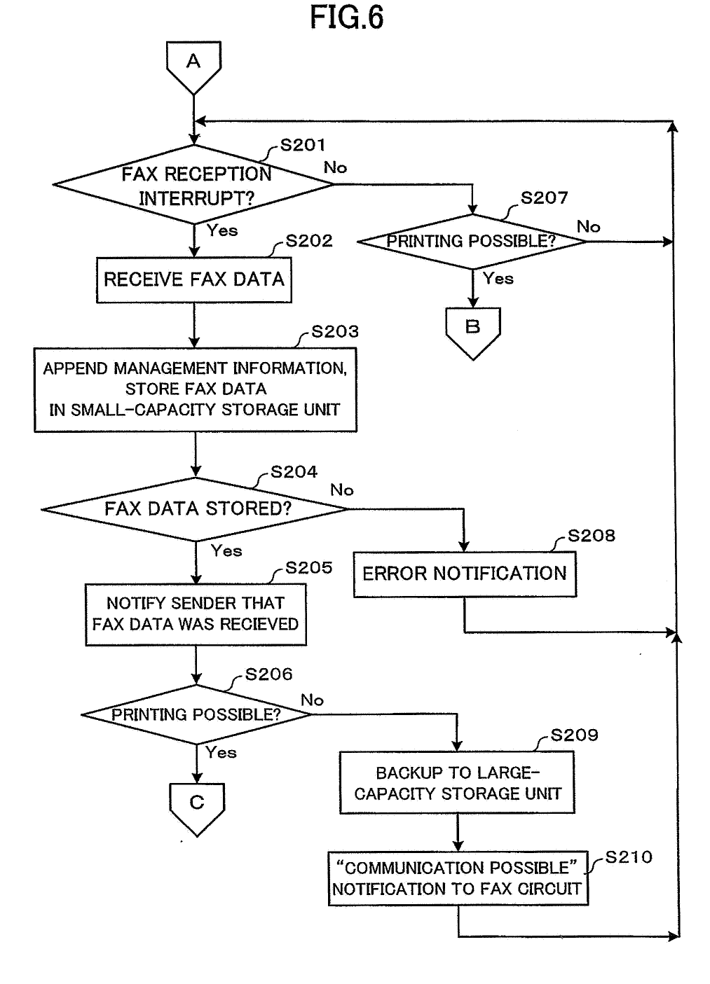

Next, the printing/backup processing of the composite machine 100 will be described with reference to the flowchart in FIG. 6. Printing/backup processing is conducted in order to hold fax data received by the composite machine 100 until it is printed, even in when the power is cut off before printing is completed.

Printing/Backup Processing

When power-on processing has finished, the print function unit 500 of the composite machine 100 commences printing/backup processing. Specifically, the print function unit 500 loads into the RAM 102 a program for conducting printing/backup processing, included in the various programs 700 stored in the large-capacity storage unit 109.

First, the print function unit 500 determines whether or not there is a fax data reception interrupt (step S201). Specifically, when the print function unit 500 recognizes a signal from the fax circuit 107 provided to the CPU 101 that notifies receipt of fax data (step S201; Yes), the process proceeds to step S202. On the other hand, if the print function unit 500 conducts a timer interrupt in a predetermined interval using a clock counter provided in the CPU 101 (step S201; No), the process proceeds to step S107.

In step S207, the print function unit 500 determines whether or not printing is possible (step S207). Specifically, the print function unit 500 conducts processing equivalent to the processing in step S101 conducted in power-on processing.

In cases where the print function unit 500 determines that printing is possible (step S207; Yes), power-on processing is executed. As a result, the composite machine 100 is able to print unprinted fax data stored in memory (the small-capacity storage unit 108, the large-capacity storage unit 109) while the print function unit 500 is in standby waiting for fax data from the information processor 200. On the other hand, in cases where printing is not possible (step S207; No), the print function unit 500 causes the process to move to step S201.

In step S202, the fax communication unit 504 receives the fax data generated by the fax data generator unit 510 built in the information processor 200 via the telephone line 300 (step S202). Specifically, the fax communication unit 504, after negotiating with the fax communication unit 511, temporarily stores the fax data into a buffer 111 provided in the fax circuit 107.

Subsequently, the print function unit 500 stores the received fax data in the small-capacity storage unit 108 (step S203). Specifically, the print function unit 500 cooperates with the memory control unit 502 to store the fax data stored in the buffer 111 in the small-capacity storage unit 108 via the CPU 101. At this point, the print function unit 500 appends the management information 601 generated by the CPU 101 to the fax data, and stores the data in the small-capacity storage unit 108.

Next, the print function unit 500 determines whether or not the storing of the fax data into the small-capacity storage unit 108 has been completed within a communication time set by the fax communication standard (step S204). Specifically, the print function unit 500 determines whether or not a timeout signal is provided from the fax communication unit 504 before the fax data stored in the buffer 111 is completely stored in the small-capacity storage unit 108.

In cases where the print function unit 500 determines that the received fax data has not been completely stored in the small-capacity storage unit 108 (step S204; No), an error notification is sent to the information processor 200 (step S208). Specifically, the print function unit 500 commands the fax communication unit 504 to send a signal indicating an error notification to the information processor 200. At this point, the fax communication unit 504 sends a signal indicating an error notification set by the fax communication standard to the information processor 200 via the telephone line 300.

As a result, the user is able to acknowledge that the fax data received at the composite machine 100 was not printed correctly at the composite machine 100.

On the other hand, in step S204, in cases where the print function unit 500 determines that the received fax data has been completely stored in the small-capacity storage unit 108 (step S204; Yes), the sender, i.e. the information processor 200, is notified that receipt of the fax data is completed (step S205). Specifically, the print function unit 500 commands the fax communication unit 504 to send a signal indicating that receipt of the fax data is completed to the information processor 200. At this point, the fax communication unit 504 sends a signal indicating that receipt of the fax data is completed as set by the fax communication standard to the information processor 200 via the telephone line 300.

Next, the print function unit 500 determines whether or not printing is possible (step S206). Specifically, the print function unit 500 conducts processing equivalent to the processing of step S101 in power-on processing.

In cases where the print function unit 500 determines that printing is possible (step S206; Yes), the processing of steps S107-S109 in power-on processing is executed. As a result, the composite machine 100 is able to print fax data sent from the information processor 200. On the other hand, when it is determined that printing is not possible (step S206; No), the print function unit 500 causes the process to proceed to step S209.

In step S209, the print function unit 500 backs up the fax data 600 stored in the small-capacity storage unit 108 to the large-capacity storage unit 109 (step S209). Specifically, the print function unit 500 cooperates with the memory control unit 502 to forward the fax data 600 stored in the small-capacity storage unit 108 to the large-capacity storage unit 109. At this point, the management information 601 is coordinated with the fax data 600 and stored in the large-capacity storage unit 109. However, when there is insufficient free space on the large-capacity storage unit 109 to store any more fax data 600, the backup overwrites fax data 600 with which is associated the management information 601 wherein the printing complete flag 806 is “1”.

The print function unit 500 notifies the fax circuit 107 that fax communication may be enabled (step S210). Specifically, the print function unit 500 conducts processing equivalent to the processing of step S109 in power-on processing.

In other words, the composite machine 100 in accordance with the present embodiment of the invention does not accept new fax data sent to the composite machine 100 until the backup in step S209 is completed.

As a result of the composite machine 100 executing the above printing/backup processing, the composite machine 100 can hold received fax data until printing is completed, even when the power is cut off before printing is completed.

It should be appreciated that the invention is not limited to the above-described embodiment, and a variety of variants and applications thereof are possible.

For example, in the above-described embodiment, it is configured such that when the fax data 600 temporarily stored in the small-capacity storage unit 108 is printed, the printing complete flag 806, included in the management information 601, was changed to “1”. In addition, it is configured such that the fax data 600 stored in the small-capacity storage unit 108 is overwritten as a result of the fax circuit 107 receiving subsequent fax data 600. However, the invention, not being limited thereby, may also be configured such that fax data 600 stored in the small-capacity storage unit 108 is deleted when the printing or the backup of the fax data 600 is completed. In such cases, it is not necessary to provide the printing complete flag 806 in the management information 601. Furthermore, it is not necessary for the print function unit 500 to execute the processing of step S1106 in power-on processing.

In addition, in the above-described embodiment, it is configured such that the printing complete flag 806 of the management information 601 is changed to 1 when the fax data 600 stored in the large-capacity storage unit 109 is printed. Also, it is configured such that when fax data 600 is forwarded from the small-capacity storage unit 108 to the large-capacity storage unit 109 when there is insufficient free space in the large-capacity storage unit 109, fax data 600 stored in the large-capacity storage unit 109 is overwritten by the forwarded fax data 600. However, the invention, not being limited thereby, may also be configured such that, when the printing of the fax data 600 stored in the large-capacity storage unit 109 is completed, the fax data 600 stored in the small-capacity storage unit 108 is deleted. In such cases, it is not necessary to provide the printing complete flag 806 in the management information 601. Furthermore, it is not necessary for the print function unit 500 to execute the processing of step S106 in power-on processing.

Furthermore, in the above-described embodiment, the backup of the fax data 600 stored in the small-capacity storage unit 108 to the large-capacity storage unit 109 is conducted according to a program for executing backup processing. However, the invention, not being limited thereby, may also be configured such that the fax data 600 stored in the small-capacity storage unit 108 is forwarded to the large-capacity storage unit 109 using a DMA method and bypassing the CPU 101.

In addition, it may also be configured such that the above-described power-on processing commences when at least one data item is selected from among a list displayed on the panel 117, and a print command is given.

In such cases, for example, the CPU 101 refers to the printing complete flag 806 of the management information 601 stored in the large-capacity storage unit 109 via the memory control ASIC 103, and generates a list of the fax data, printing of which is incomplete. The CPU 101 provides the generated list to the panel 117 via the I/O control ASIC 106, and causes the data to be displayed thereon. In this state, the panel 117 receives commands selecting at least one data item to print from among the list being displayed. The panel 117 then provides these received commands to the CPU 101 via the I/O control ASIC 106. At this point, the CPU 101 (the print function unit 500) loads into the RAM 102 the program for executing power-on processing, included in various programs 700 stored in the large-capacity storage unit 109, and commences the power-on processing described in the foregoing.

Furthermore, in step S103 of the above-described power-on processing, printing is conducted by the printer driver unit 501 generating print image data, based on the print data that can be interpreted by the printer 115, and providing this data to the printer 115. However, the invention, not being limited thereby, may also be configured such that, for example, the printer driver unit 501 develops the print data provided by the image processing ASIC 104 into video data, and sends this video data along with control commands to the printer 115. In addition, when printing image data received via the various interfaces 116, or image data received from the scanner 113, the printer driver unit 501 may also develop the print data provided by the image processing ASIC 104 into video data, and cause the printer 115 to print the video data.

In addition, in the above-described embodiment, the programs executed by the CPU 101 are stored in advance in the large-capacity storage unit 109. However, in the invention, not being limited thereby, the foregoing methods for providing the programs for executing the above-described processing are optional, and for example may be provided via a communication medium such as the internet, or distributed stored on storage media such as memory cards.

What is claimed is:

1. A composite machine for printing facsimile data received by using facsimile communication, the machine comprising:
a first non-volatile storage device having a storage area of a predetermined capacity;
a second non-volatile storage device that is capable of storing data at higher speed than the first storage device is, and having a storage area smaller than the predetermined capacity;
a temporary storage unit that stores the facsimile data in the second storage device;
a print execution unit that executes printing when the storing of the facsimile data is completed, in a case where printing is possible; and
a backup unit that stores the facsimile data in the first storage device when the storing of the facsimile data is completed, in a case where printing is not possible.

2. The composite machine according to claim 1, further comprising at least one of:
an external interface that conducts communication with a connected external device, the print execution unit printing received image data when the image data is received via the external interface;
a network interface that conducts communication with an external device via a network, the print execution unit printing received image data when the image data is received via the network interface; and
an image reading apparatus that reads an original and generates image data, the print execution unit printing received image data when the image data generated by the image reading apparatus is received.

3. The composite machine according to claim 1, further comprising:
a power supply detector that detects when power is supplied to the device;
wherein, when it is detected that power has been supplied to the device, the print execution unit prints facsimile data, printing of which is incomplete, that is stored in the second storage device, and after this printing, prints facsimile data, printing of which is incomplete, that is stored in the first storage device.

4. The composite machine according to claim 1, further comprising:
a panel that displays a list of facsimile data, printing of which is incomplete, that is stored in the first storage device, and receives a command selecting at least one data item from among the list;
wherein the print execution unit, when the panel receives the command, prints facsimile data, printing of which is incomplete, that is stored in the second storage device, and after this printing, prints facsimile data, printing of which is incomplete, that is stored in the first storage device.

5. The composite machine according to claim 1, wherein:
the temporary storage unit associates and stores the facsimile data with ancillary information for managing the facsimile data;
the backup unit associates and stores the facsimile data and the ancillary information; and
the ancillary information contains reception time when the facsimile data was received, and printing completion determination information that indicates whether or not the printing of the facsimile data has been completed.

6. The composite machine according to claim 5, wherein:
in a case where the reception time included in the ancillary information stored in the first storage device is identical to the reception time included in the ancillary information stored in the second storage device, the print execution unit does not print the facsimile data corresponding to the ancillary information stored in the first storage device.

7. The composite machine according to claim 5, wherein:
in a case where the printing completion determination information included in the ancillary information indicates that printing is not completed, the print execution unit prints the facsimile data corresponding to the ancillary information.

8. A printing system comprising:
a composite machine that prints facsimile data received by using facsimile communication; and
an information processing device that sends the facsimile data to the composite machine;
the information processing device including:
a facsimile data generator that generates facsimile data; and
a sender that sends the generated facsimile data to the composite machine; and
the composite machine including:
a first non-volatile storage device having a storage area of a predetermined capacity;
a second non-volatile storage device that is capable of storing data at higher speed than the first storage device is, and having a storage area smaller than the predetermined capacity;
a receiver that receives the facsimile data sent from the information processing device;
a temporary storage unit that stores the facsimile data in the second storage device;
a print execution unit that executes printing when the storing of the facsimile data is completed, in a case where printing is possible; and
a backup unit that stores the facsimile data in the first storage device when the storing of the facsimile data is completed, in a case where printing is not possible.

9. A method for holding facsimile data in a composite machine for printing facsimile data received by using facsimile communication, the machine including a first non-volatile storage device having a storage area of a predetermined capacity and a second non-volatile storage device that is capable of storing data at higher speed than the first storage device and that has a storage area smaller than the predetermined capacity, and the method comprising the steps of:
temporarily storing the facsimile data in the second storage device;
executing printing when the storing of the facsimile data is completed, when printing is possible; and
backing up the facsimile data by storing it in the first storage device when the storing of the facsimile data is completed, when printing is not possible.

10. A computer program product for causing a computer of a composite machine to execute certain procedures, the machine being a device for printing facsimile data received by using facsimile communication and including a first non-volatile storage device having a storage area of a predetermined capacity and a second non-volatile storage device that is capable of storing data at higher speed than the first storage device and has a storage area smaller than the predetermined capacity, and the procedures including:
temporarily storing the facsimile data in the second storage device;
executing printing when the storing of the facsimile data is completed, when printing is possible; and
backing up the facsimile data by storing it in the first storage device when the storing of the facsimile data is completed, when printing is not possible.
